(19) United States
(12) Patent Application Publication
(10) Pub. No.: US 2020/0356926 A1
(43) Pub. Date: Nov. 12, 2020

(54) PERSONNEL EVALUATION SYSTEM

(71) Applicant: Management HR Partners Co., Ltd., Tokyo (JP)

(72) Inventors: Takeshi YAMAGIWA, Tokyo (JP); Ayako YAMAGIWA, Tokyo (JP)

(21) Appl. No.: 16/958,134

(22) PCT Filed: Dec. 17, 2018
(86) PCT No.: PCT/JP2018/046343

§ 371 Date: Jun. 25, 2020

(30) Foreign Application Priority Data
Dec. 29, 2017 (JP) 2017-255169

(51) Int. Cl. G06Q 10/06; G06Q 10/10; G06Q 30/02; G06F 7/483; H04L 29/06

(52) U.S. Cl. CPC G06Q 10/0639; G06Q 10/105; H04L 63/08; G06F 7/4833; G06Q 30/0282

(57) ABSTRACT

A personnel evaluation method and system is provided which require a few steps for personnel evaluation and objectively evaluate personnel. In such a system, an evaluator simply inputs or selects in the evaluation item column whether a subject (an evaluatee) is rated higher or lower than the evaluator oneself as a reference, and thus a only a few steps are required for evaluation. And then it is possible to determine whether the subject has a high rating or a low rating by calculating a mean rating of the subject with obtaining such ratings from a plurality of evaluators.

The present disclosure relates to a system to evaluate personnel in a group such as a company or an organization.

### BACKGROUND ART

In companies, it is important to evaluate employees appropriately, such as to determine the reward and/or the post thereof. Therefore, the method and system to evaluate employees working in a company have been developed in various ways. Following are some examples.

Patent Document 1

Japanese Unexamined Patent Application Publication No. 2006-195642

Patent Document 2

Japanese Unexamined Patent Application Publication No. 2002-99682

Patent Document 3

Japanese Unexamined Patent Application Publication No. 2002-123655

Patent Document 4

Japanese Unexamined Patent Application Publication No. 2006-323495

A system which enables all members of an organization to perform personnel evaluations with respect to all the members is disclosed in Patent Document 1. When the members form personnel evaluation tables on a computer and transmit them to a tabulator respectively, each table is automatically totalized on the computer of the tabulator.

An evaluating system which is capable of evaluating employees while keeping high-level secrecy on WEB is disclosed in Patent Document 2. The system includes that an employee evaluates oneself as a subject (an evaluatee) of the evaluation, then a supervisor of the employee evaluates the employee, and then a supervisor who is even higher than said supervisor of the employee evaluates the employee.

A personnel evaluation system based on one's achievement is disclosed in Patent Document 3. The system includes ranking individual achievement in a former half and a latter half of a prescribed period and throughout the period respectively and conducting a personnel evaluation based on the achievement depending on each ranking.

A system which is capable of integrally performing a production management, a management analysis, a personnel evaluation, or the like is disclosed in Patent Document 4. The system includes not only evaluating the work performance of each individual but also giving the “affective points” given to each individual to the others.

### BRIEF DESCRIPTION

According to the system in Patent Document 1, one-sided evaluation can be eliminated, because all members of the organization conduct personnel evaluations with respect to all members. However, a wide variety of evaluation items in the personnel evaluation table to be input by each member cause problem to complicate the evaluation oneself and take time to evaluate the members.

In the system in Patent Document 2, the supervisor of the evaluatee and the supervisor who is even higher than said supervisor evaluate the evaluatee based on the self-evaluation result of the evaluatee according to a wide variety of evaluation items. The problem of evaluating multiple items is as described above. In addition, the problem of lack of objectivity may arise, since a criterion of evaluation is the self-evaluation and the evaluatee is evaluated just by his/her direct supervisor.

According to the system in Patent Document 3, the score can be adjusted in consideration of the working attitude such as individual discipline, responsibility, positiveness and cooperativity after the evaluatees are ranked based on their performances such as sales and the score is given corresponding to the ranking. This is not, however, suitable for evaluating the personnel who are assigned to the departments such as management division, that are hardly connected to sales performance. Furthermore, the score adjustment based on the ranking has a significant influence by the person performing the adjustment, which can cause the problem of lack of objectivity.

The system disclosed in Patent Document 4 allows not only to grasp the sales transition and the cost situation, but also to support the introduction of an effective pay-for-performance that eliminates unfairness by considering the points which are initially assigned to the each individual equally and then are given to the others in consideration of human nature and abilities. However, since there is no standard for the weight of one point of “affective point”, the value of the point differs depending on the person who gives the point. Also, a degree of the “affective point” to be given tends to be influenced by a person's emotions such as likes or dislikes. As a result, the evaluation based on the “affective point” may not be an appropriate evaluation.

In view of the foregoing problems, the present disclosure provides personnel evaluation method and system which require a small number of steps for personnel evaluation and objectively evaluate personnel.

The present disclosure has solved the above-mentioned problems by a personnel evaluation system in which a plurality of evaluators evaluates a subject or an evaluatee according to evaluation items comprising:
a display displaying the subject and the evaluation items with respect to each the plurality of evaluators;
an input means inputting a rating determined by selecting whether the subject is rated higher or lower than the evaluator oneself as a reference;
a memory storing the rating; and
a calculator calculating a mean rating of the subject dividing the sum of ratings which the subject has obtained by the total number of the evaluators and when the rating is not quantified, the calculator is converting a good rating which is obtained in the case of the subject is rated higher than the evaluator oneself as a reference to a larger fixed numerical score than that of a poor rating which is obtained in the case of the subject is rated lower than the evaluator oneself as a reference and the poor rating to a smaller fixed numerical score than that of the good rating.

According to the personnel evaluation system of the present disclosure, the following effect can be obtained. Firstly, the evaluation system requires only a few steps, in which an evaluator simply selects whether a subject (an evaluatee) is rated higher or lower than the evaluator oneself as a reference. Moreover, an objective evaluation of the subject can be obtained by referring to the results of ratings provided by a plurality of evaluators who has evaluated the subject.

Furthermore, even if the rating is not quantified, it is possible to determine whether the subject has a high rating or a low rating by converting a good rating which is obtained in the case of the subject is rated higher than the evaluator oneself as a reference to a larger fixed numerical score than that of a poor rating which is obtained in the case of the subject is rated lower than the evaluator oneself as a reference and the poor rating to a smaller fixed numerical score than that of the good rating and calculating a mean rating of the subject by dividing the sum of ratings which the subject obtains by the total number of the evaluators.

Also, when an evaluator and a subject (an evaluatee) mutually evaluate one another according to the evaluation items, they can know how they rate one another.

When there are many evaluators and subjects and in addition the evaluators and the subjects mutually evaluate one another as an evaluator and an evaluatee according to the evaluation items, it is possible to obtain objective evaluation of members of the entire organization to which the evaluators and the subjects belong and information about the relationship of the evaluators and the subjects such as whether the evaluator and the subject mutually accept one another and there are any troubles between them.

Also, a first adjustment rating of a subject can be calculated by adding a score obtained by subtracting an average score of ratings which one evaluator has given to all subjects (evaluatees) from the mean rating of said one evaluator as a subject to a score which said one evaluator has given to the subject. And, a first adjustment mean rating of the subject can be calculated by dividing the sum of the first adjustment ratings of the subject by the total number of the evaluators who have evaluated the subject. This allows to obtain an objective evaluation of the subject.

Further, a log adjustment number of evaluators can be calculated by adding a number which is greater than zero to the logarithm (the base is b>0, b≠1) of the number of the evaluators who have evaluated a subject (an evaluatee), and a log adjustment rating can be calculated by multiplying the mean rating of the subject or the first adjustment mean rating of the subject by the log adjustment number of the evaluators. Accordingly, the objective relative evaluation of the subject in the organization to which the subject belongs corresponding to the number of the evaluators can be obtained.

Furthermore, with respect to a subject who has been evaluated by Nmax (Nmax≥4) evaluators, at least one standard deviation for the total number of combinations of the ratings of every n (Nmax−1≥n≥2) evaluators can be calculated and a mean of the standard deviation(s) can be calculated so that a reference of a power approximation is obtained. And then a power approximation expression can be calculated based on the references of the power approximation with respect to every n evaluators. The number of the evaluators who have evaluated the subject can be applied to the power approximation expression so that the power approximation adjustment number of the evaluators is obtained. And the mean rating of the subject or the first adjustment mean rating of the subject can be divided by the power approximation adjustment number of the evaluators to obtain a power approximation adjustment rating. Accordingly, more objective relative evaluation in the organization to which the subject belongs in relation to the subject corresponding to the number of the evaluators can be obtained, since the above configuration prevents the subject from having a high rating when the subject has been evaluated by a lot of evaluators and has obtain low scores.

In addition, at least one standard deviation for the total number of combinations of the ratings of every n (Nmax≥n≥2) evaluators with respect to each a plurality of the subjects who have been evaluated by the above Nmax (Nmax≥4) evaluators can be calculated and a mean of the standard deviation(s) can be obtained. An average of the means of the standard deviation(s) with respect to the subjects in every n evaluators can be calculated to obtain a reference of a power approximation. And then, a power approximation expression can be calculated based on the references of the power approximation with respect to the every n evaluators. The number of the evaluators who have evaluated the subject can be applied to the power approximation expression so that the power approximation adjustment number of the evaluators is obtained. And the mean rating of the subject or the first adjustment mean rating of the subject can be divided by the power approximation adjustment number of the evaluators to obtain a power approximation adjustment rating. Accordingly, the objective and highly accurate relative evaluation in the organization to which the subject belongs in relation to the subject corresponding to the number of the evaluators can be obtained.

When Nmax is more than or equal to 5 (Nmax≥5), and n is less than or equal to Nmax−1 and more than or equal to 2 (Nmax−1≥n≥2), it is possible to improve the accuracy of the standard deviation, since the total number of combinations of the ratings in every n evaluators is more than or equal to 2.

Also, when a pair of subjects who have mutually evaluated one another according to evaluation items and have given a good rating to one another is extracted, it is possible to estimate whether the subjects mutually accept one another or whether there is no unfair evaluation. Furthermore, when a pair of the subjects who have mutually given a poor rating to one another is extracted, it is possible to know whether there are any troubles between them.

### BRIEF DESCRIPTION OF DRAWINGS

FIG. 1 is a configuration of a personnel evaluation system according to one embodiment.

FIG. 2 is a data base server of the personnel evaluation system in FIG. 1.

FIG. 3 is a flowchart which shows processes by using a management terminal of the personnel evaluation system in FIG. 1.

FIG. 4 is a flowchart which shows processes by using a personnel terminal of the personnel evaluation system in FIG. 1.

FIG. 5 is a flowchart which shows processes by using an evaluator terminal of the personnel evaluation system in FIG. 1.

FIG. 6 is an image displayed on the evaluator terminal of the personnel evaluation system in FIG. 1 when the evaluator evaluates the subject.

FIG. 7 is a first image on the management terminal or the personnel terminal of the personnel evaluation system in FIG. 1, which shows the totaled result of the rating.

FIG. 8 shows a power approximation expression of one embodiment of the personnel evaluate system.

FIG. 9 is a second image on the management terminal or the personnel terminal of the personnel evaluation system in FIG. 1, which shows the totaled result of the rating.

### DESCRIPTION OF EMBODIMENTS

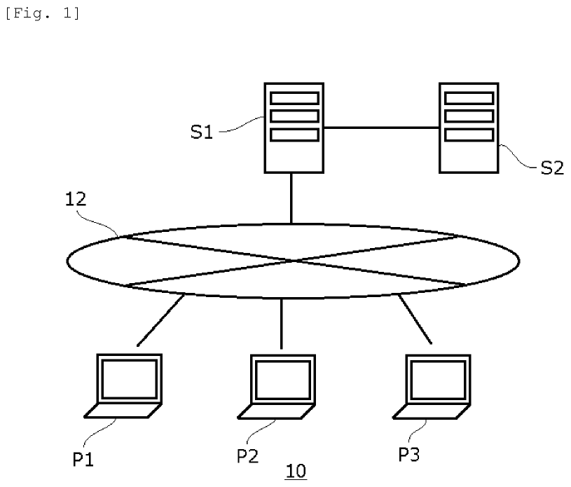

Some exemplary embodiments of the present invention will be described below with reference to FIGS. 1 to 9. The present invention, however, is not limited to these embodiments.

As shown in FIG. 1, a personnel evaluation system 10 of one embodiment includes a management terminal P1, a personnel terminal P2, an evaluator terminal P3 and a web server S1 which is connectable to all terminals P1, P2 and P3 via a communication line 12 such as internet or private line. Dedicated terminals are not needed for the management terminal P1, the personnel terminal P2 and the evaluator terminal P3. Instead, when a user logs into the web server S1 by inputting ID/email address and password set for a manager, a personnel or an evaluator, an authority of the manager, the personnel and the evaluator can be respectively assigned to the user adequately.

The web server S1 is connected to a database server S2. The web server S1 and database server S2 can be separate servers as illustrated or a single server which has two functions. For example, a personal computer, a tablet terminal or a mobile phone terminal can be used for the management terminal P1, the personnel terminal P2 and the evaluator terminal P3.

The web server S1 displays each image as detailed below on the management terminal P1, the personnel terminal P2 and the evaluator terminal P3 via the communication line 12 respectively. And then, when data are input into the terminals P1, P2 and P3 by users, the web server S1 acquires the data. The input data which the web server S1 acquires are stored in the database server S2.

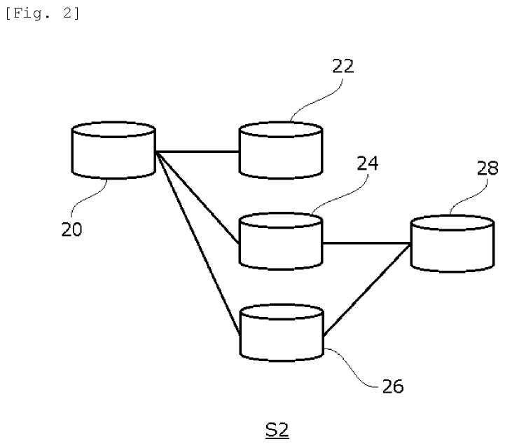

As shown in FIG. 2, the database server S2 includes an organization master data 20, a personnel master data 22, a member master data 24, an evaluation period master data 26 and an evaluation master data 28. The database server S2 also can include a master data which stores the information relating to the management terminal P1 such as a management ID, a password, and a e-mail address.

The organization master data 20 stores an organization ID and password (both of them are also referred to as “organization account” hereinafter) which are assigned to each organization such as a company or group. Further information such as name of the organization can be also stored. Preferably, the information stored in the organization master data 20 can be editable (including creating, deleting, and browsing; the same shall apply hereinafter.) only on the management terminal P1.

The personnel master data 22 stores the organization ID which is also stored in the organization master data 20, a personnel ID and password (both of them are also referred to as “personnel account” hereinafter) which are assigned to a personnel in each organization. Additional information such as name of the personnel can be also stored with respect to each personnel ID. The information stored in the personnel master data 22 can be editable by the manager. Further, the information stored in the personnel master data 22 except for the organization ID can be editable by the personnel having personnel ID.

The member master data 24 stores the organization ID which is also stored in the organization master data 20, a member ID and password (both of them are also referred to as “member account” hereinafter) which are assigned to a member in each organization. Additional information such as name of the member can be also stored with respect to each member ID. Also, a group ID can be assigned to each group consisting of the predetermined members. The information stored in the personnel master data 22 can be editable by the manager. Further, the information stored in the personnel master data 22 except for the organization ID can be editable by the personnel having personnel ID.

The evaluation period master data 26 stores the organization ID which is also stored in the organization master data 20 and evaluation period data regarding an evaluation period. The evaluation period comprises start time and finish time which allow to determine when it starts and ends by inputting such as month/year, day/month/year, or time/day/month/year. Additional information such as title of the evaluation period can be also stored with respect to each evaluation period. Also, the member ID and the group ID can be additionally stored in the evaluation period master data 26 so that the evaluation period data are linked thereto respectively.

The evaluation master data 28 stores an evaluator ID which is assigned to an evaluator, an evaluatee ID which is assigned to a subject (an evaluatee), evaluation period data and a rating. The evaluator ID is identical with the member ID which is assigned to the evaluator, and the evaluatee ID is identical with the member ID which is assigned to the subject (the evaluatee). Not only the evaluator ID, the evaluatee ID and the evaluation period but also the name of the member, the relationship between the subjects (the evaluator and the evaluatee), the title of the evaluation period, and comments input when performing a personnel evaluation can be stored in the evaluation master data 28. The rating is input into the evaluator terminal P3 and stored in the evaluation master data 28 through the web server S1 as described below.

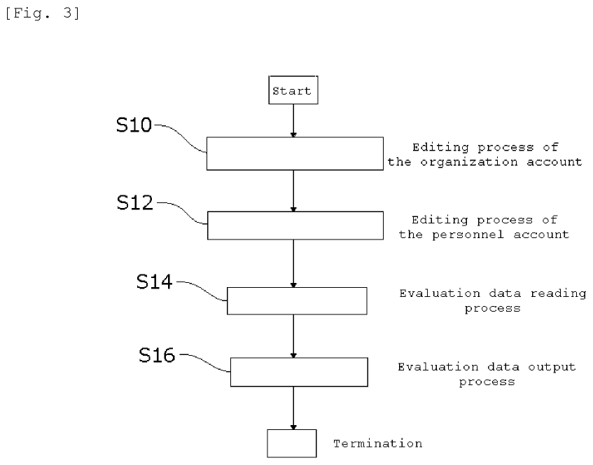

FIG. 3 is a flowchart which shows processes by using the management terminal P1. The management terminal P1 can mainly perform an editing process of the organization account S10, an editing process of the personnel account S12, an evaluation data reading process S14 and an evaluation data output process S16. As described below, the management terminal P1 also can perform an editing process of the member account which can be edited by using the personnel terminal P2. Each process can be conducted in random order regardless of the flow of the illustrated flowchart.

When the web server S1 is accessed from the management terminal P1 and the editing process of the organization account S10 is performed, an edit screen for the organization account is displayed and data about the organization ID are read out from the database server S2. Then, the organization account can be edited by operating the management terminal P1. The editing process of the personnel account S12 is also similar to the editing process of the organization account S10. The variety of information of the edited organization account and the personnel account are stored on the corresponding masters of the database server S2. All of various data can be edited at once by loading CSV file data into the database server S2. The further explanation about such the edit screen will be omitted, since a well-known art can be applied. The evaluation data reading process S14 and the evaluation data output process S16 will be described after explanations of the evaluation data input process by operating the evaluator terminal P3 for convenience.

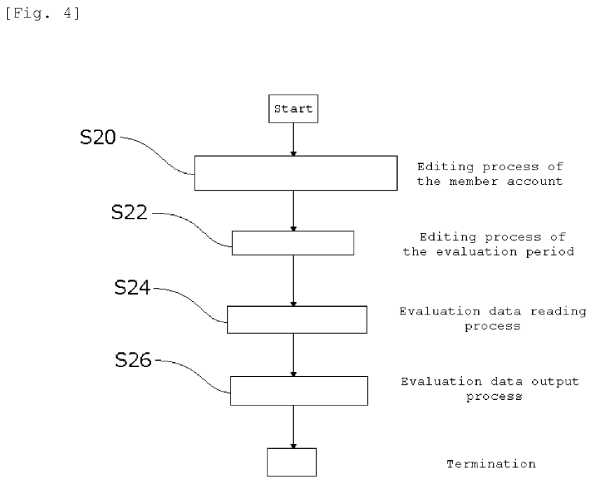

FIG. 4 is a flowchart which shows processes by using the personnel terminal P2. The personnel terminal P2 can mainly perform an editing process of the member account S20, an editing process of the evaluation period S22, an evaluation data reading process S24 and an evaluation data output process S26. The personnel terminal P2 also can perform any processes which can be performed by using the evaluator terminal P3 as described below, since the personnel is also one of the members of the organization. Each process can be conducted in random order regardless of the flow of the illustrated flowchart.

When the web server S1 is accessed from the personnel terminal P2 and the editing process of the member account S20 is performed, an edit screen for the member account and data about the member ID read out from the database server S2 are displayed on the personnel terminal P2. Then, the member account can be edited by operating the personnel terminal P2. The variety of information of the edited member account is stored on the corresponding masters of the database server S2. All of various data can be edited at once by loading CSV file data into the database server S2. The further explanation about such the edit screen will be omitted, since a well-known art can be applied.

When the editing process of the evaluation period S22 is performed by using the personnel terminal P2, an edit screen for setting an evaluation period every organization ID, member ID or group ID is displayed. The evaluation period can be edited by operating the personnel terminal P2 and stored on a corresponding master of the database server S2. The evaluation data reading process S24 and the evaluation data output process S26 will be described after explanations of the evaluation data input process by operating the evaluator terminal P3 for convenience.

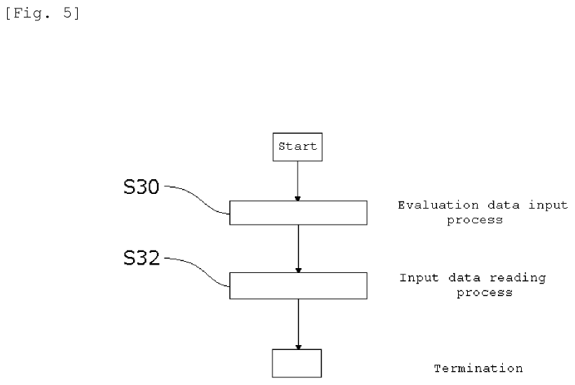

FIG. 5 is a flowchart which shows processes by using the evaluator terminal P3. The evaluator terminal P3 can mainly perform an evaluation data input process S30 and an input data reading process S32. Each process can be conducted in random order regardless of the flow of the illustrated flowchart.

When the web server S1 is accessed from the evaluator terminal P3 and evaluation data input process S30 is performed, list of data about the subject (the evaluatee) is displayed on the evaluator terminal P3. It may be possible to search for a subject (an evaluatee) by operating the evaluator terminal P3. In the case of being set an evaluation period with respect to every member ID of subjects (evaluatees), group ID or organization ID to which subjects (evaluatees) belong, only when the web server S1 is accessed from the evaluator terminal P3 during for the above evaluation period, the subjects (the evaluatee) can be evaluated by using the evaluator terminal P3.

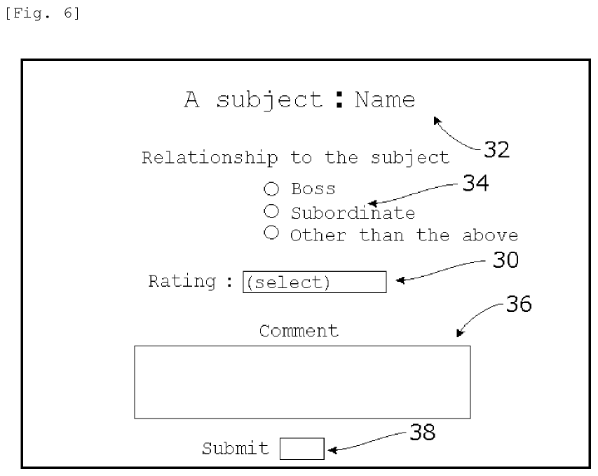

FIG. 6 is an image displayed on the evaluator terminal P3 when the evaluator evaluates the subject (the evaluatee). As shown in FIG. 6, there is a subject's name filed 32 on the screen. The evaluator operates the evaluator terminal P3 and inputs a rating determined by selecting whether a subject (an evaluatee) is rated higher or rated lower than the evaluator oneself as a reference in an evaluation item column 30. Then, when a submit button 38 is clicked, the rating is transmitted to the evaluation master data 28 (See FIG. 2) and stored therein. The evaluator can input directly in the evaluation item column 30 whether the subject (the evaluatee) has a good rating or a poor rating, or select a rating from a list in the evaluation item column 30 prepared in advance. Also, the rating can be input as a language, such as Great, Good and Poor, or a numerical character, such as 5 (Super High), 4 (High), 2 (Law) and 1 (Super Low). In short, it is a feature that an evaluation does not include “Normal” or “Same as the evaluator oneself” as a reference, such as Fair or 3 (Equal), in the rating. Accordingly, the evaluation requires only a few steps, because the evaluator simply selects whether the subject (the evaluatee) is rated higher or lower than the evaluator oneself as a reference. Moreover, an objective evaluation result of the subject (the evaluatee) can be obtained by referring to the evaluation results by a plurality of evaluators.

Additionally, it is preferable that an evaluator and a subject (an evaluatee) operate the evaluator terminal P3 respectively to mutually evaluate one another according to the evaluation item column 30. This allows the evaluator and the subject (the evaluatee) to know how they rate one another. When a plurality of evaluators and subjects (evaluatees) operate the evaluator terminal P3 respectively to mutually evaluate one another according to the evaluation item column 30, the maximum effect can be obtained. In other words, various information, such as objective evaluation results of the members of the entire organization to which the evaluators and the evaluatees belong and relationship between the evaluator and the evaluatee, or such as whether the evaluator and the evaluatee mutually accept one another and there are any troubles between them, can be obtained.

Relationship indication item 34 which shows a relationship between the evaluator and the subject (the evaluatee) by inputting or selecting such that whether the evaluator is the boss of the subject (the evaluatee), subordinate of the subject (the evaluatee) or other than the above can be provided on the display screen during evaluation. When the relationship indication item 34 is provided and the evaluator input or select own position against the subject (the evaluatee), an evaluation tendency based on the differences of the positions of the evaluator and the subject (the evaluatee) can be understood. Specifically, the evaluation tendency such as whether the subject obtains a high rating or low rating from either the boss and subordinate or one of the boss and subordinate can be obtained. Accordingly, characteristics, strong and weak points, and bad points of the subject can be estimated. A comment column 36 can be provided as a free description column. Further, various item for human resource evaluation can be provided. To cause beneficial effect or minimize steps for human resource evaluation, however, it is preferable that any additional item for human resource evaluation other than the evaluation item column 30 is not provided.

When an evaluator operates the evaluator terminal P3 and performs the input data reading process S32 (See FIG. 5), the web server S1 acquires a rating of a subject whom the evaluator has already evaluated and this rating is displayed on the screen of the evaluator terminal P3. Search function for a subject can be provided to allow the evaluator to display a rating of a desired subject. Also, functions to modify or delete the displayed rating can be provided. This allows the evaluator to evaluate a subject while comparing a current rating with the past rating which the evaluator gave to the subject before.

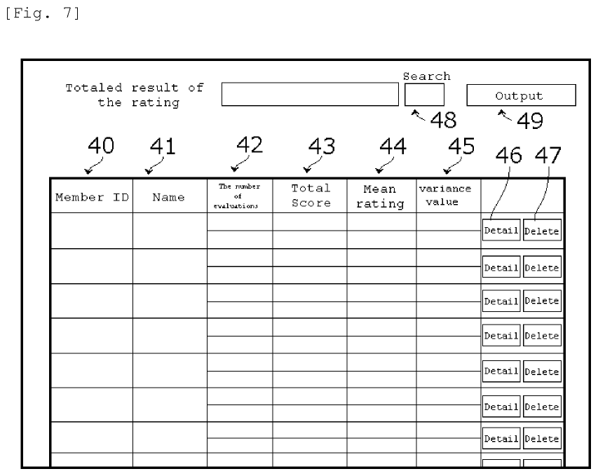

When the management terminal P1 executes the evaluation data reading process S14 (See FIG. 3), the web server S1 obtains the rating from the data server S2 to display information such as the following on the screen of the management terminal P1. As shown in FIG. 7, the member ID of the member belonging to a given organization account is displayed in a member ID column 40. Name of the member is displayed in a name column 41. The number of the evaluatees whom this member has already evaluated is displayed in the upper side of the number of evaluations column 42 and the number of the evaluators who has already evaluated this member is displayed in the lower side of the number of evaluations column 42. Total ratings given by this member to the evaluatees are displayed in the upper side of the total score column 43 and total ratings which this member obtains are displayed in the lower side of the total score column 43. A mean score which is calculated by dividing the total ratings given by this member to the evaluatees by the number of the evaluatees whom this member has already evaluated is displayed in the upper side of a mean column 44. A mean score (a mean rating of this member) which is calculated by dividing the total ratings which this member obtains by the number of the evaluators who has already evaluated this member is displayed in the lower side of the mean column 44. The standard deviation value or variance value in relation to the ratings given by this member to the evaluatees is displays in the upper side of a variance value column 45, and the standard deviation value or variance value in relation to the ratings which this member obtains is displays in the lower side of the variance value column 45. The display appearance on the screen can be modified appropriately, any display items can be added or changed. It is preferable that at least the mean rating of the subject is displayed in the evaluation data reading process S14 to know the evaluation of the member as a subject (an evaluatee). In addition to the above, for instance, information about the character of the member can be displayed.

When a rating is input in a manner other than numerals, such as Great, Good or Poor, in the step of the evaluation data input process S30, indications in the total score column 43, the mean column 44 and the variance value column 45 are preferably converted into the numerals such that a good rating to a larger fixed numerical score than that of a poor rating and the poor rating to a smaller fixed numerical score than that of the good rating to calculate the total scores, the mean score, and the standard deviation value or variance value.

In the step of the evaluation data reading process S14 on the management terminal P1, the above various evaluation data of all member ID stored by the database server S2 can be displayed. When the group ID or the organization ID are provided, the above various evaluation data of every group ID or every organization ID can be displayed. Additionally, a search function 48 can be provided so that desired evaluation data in relation to the member ID, the group ID, the organization ID, and the name thereof can be displayed.

A function to show details of the displayed evaluation data or delete the displayed evaluation data can be provided. With reference to FIG. 7, when a detail button 46 is clicked, names and ratings input according to evaluation items of all members whom a present member who is shown in the same line as the detail button 46 has already evaluated, or names and ratings input according to evaluation items of all members who have already evaluated the present member are displayed. When a delete button 47 is clicked, memories of the evaluation data shown in the same line as the delete button 47 are deleted from the appropriate master in the database server S2.

When the number of the members whom the present member has already evaluated or who has already evaluated the present member is displayed in the number of evaluations column 42, it is possible to recognize how the present member is conscious of the other members or how the other members are conscious of the present member. When the number of the members who has already evaluated the other members or who has been already evaluated by the other members with respect to every group ID or every organization ID is displayed, it is also possible to recognize how strong the members are conscious of one another or whether the members work with being conscious of one another or the members are indifferent to the others by taking the number of the members having the group ID or the organization ID into consideration.

Displaying the mean score of the ratings which the present member has given to the subjects in the upper side of the mean column 44 allows to know the tendency of how the present member rates the other members. And displaying the mean score of the ratings which the present member has been given (the mean rating of the present member) in the lower side of the mean column 44 allows to know how the present member was rated by the other members. Accordingly, the present member can obtain an objective evaluation as a subject. In addition, displaying both above means score with respect to every group ID or every organization ID allows to know whether the group ID or the organization ID obtains generally a high or low rating, or neither.

Displaying the standard deviation or the variance value of all ratings which the present member has already evaluated in the upper side of the variance value column 45 allows to know whether the present member evaluates the other member without being biased toward either a good rating or a poor rating, and also allows to know whether the present member tends to give a high rating or a low rating to the other members. In addition, displaying the standard deviation or the variance value of all ratings which the present member has obtained in the lower side of the variance value column 45 allows to know whether the present member has been evaluated without being biased toward either a good rating or a poor rating, and also allows to know whether the present member tends to be rated high or low. Displaying both above standard deviation or variance value with respect to every group ID or every organization ID also allows to know whether there are above-mentioned tendencies in every group ID or every organization ID.

Also, various adjustment described below can be displayed in the step of the evaluation data reading process S14. For instance, an adjustment rating of a subject can be based on the rating which an evaluator obtains as a subject. Specifically, a first adjustment rating of a subject is calculated by adding a score obtained by subtracting an average score of ratings which the evaluator has given to all subjects (evaluatees) from the mean rating of the evaluator as a subject to a score which the evaluator has given to the subject. And, a first adjustment mean rating of the subject can be calculated by dividing the sum of the first adjustment ratings of the subject by the total number of the evaluators who have evaluated the subject. This allows to obtain an objective evaluation of the subject.

The objective relative evaluation in relation to the subject in the organization to which the subject belongs corresponding to the number of the evaluators can be also obtained. For instance, a log adjustment number of the evaluators is calculated by adding a number which is greater than zero to the logarithm (the base is b>0, b≠1) of the number of the evaluators who have evaluated the subject, and a common log adjustment rating is calculated by multiplying the mean rating of the subject described above or the first adjustment mean rating of the subject by the log adjustment number of the evaluators. The reason why the number which is greater than zero is added is that when the number of the evaluators is just one, the log adjustment number of the evaluators is 0. For example, an integer 1 can be applicable to the number which is greater than zero.

As mentioned above, when taking the logarithm of the number of the evaluators, the log adjustment number of the evaluators is increased with the increase of the number of the evaluators. When the log adjustment number of the evaluators are multiplied by the mean rating of the subject or the first adjustment mean rating of the subject, the more the evaluators, the high rating the subject obtains. It is based on a point that the subject whom the large number of the evaluators evaluate should be rated high.

When a power approximation adjustment number of the evaluators described below is not capable of being calculated or there are no subjects who has been evaluated by more than or equal to 5 evaluators, the log adjustment rating is preferably calculated.

Additionally, an objective relative evaluation in relation to the subject in the organization to which the subject belongs corresponding to the number of the evaluators can be also obtained using the following method. Firstly, a subject who has been evaluated by more than or equal to 4 evaluators or by Nmax (Nmax≥4) evaluators is extracted. And then, at least one standard deviation for the total number of the combinations of the ratings which are obtained by n (Nmax≥n≥2) evaluators is calculated and the mean of the standard deviation is calculated to obtain a reference of the power approximation. The more the total number of combinations of the ratings which are obtained by n (Nmax≥n≥2) evaluators, the higher accuracy. When the total number of combinations of the ratings which are obtained by n (Nmax≥n≥2) evaluators is 1, a mean of the standard deviation is the standard deviation itself. The reason why Nmax is more than or equal to 4 is that the power approximation expression of the curve is not obtained if the number of the references of the power approximation is below 3.

Secondary, a power approximation expression is obtained from the references of the power approximation with respect of the every n evaluators. A least square method can be used for obtaining the power approximation expression. The number of the evaluators who have evaluated the subject is applied to the power approximation expression obtained above so that the power approximation adjustment number of the evaluators is obtained. And then, the mean rating of the subject or the first adjustment mean rating of the subject described above are divided by the power approximation adjustment number of the evaluators to obtain a power approximation adjustment rating. The reason why the mean rating of the subject or the first adjustment mean rating of the subject described above are divided by the power approximation adjustment number of the evaluators is that the references of the power approximation is decreased with the increase of the number of the evaluators (n), which is contrary to the point that the subject whom the large number of the evaluators evaluate should be highly evaluated. This method allows to solve the log adjustment rating problem of obtaining a high rating when the subject has been evaluated by a lot of evaluators and has obtain a low rating. Accordingly, the objective relative evaluation in relation to the subject corresponding to the number of the evaluators can be obtained.

Preferably, a plurality of subjects who have been evaluated by Nmax (Nmax≥4) evaluators can be extracted. In this case, at least one standard deviation for the total number of combinations of the ratings of every n (Nmax−1≥n≥2) evaluators with respect to each the plurality of the subjects who have been evaluated by Nmax (Nmax≥5) evaluators is calculated and a mean of the standard deviation(s) is obtained. An average of the means of the standard deviation(s) with respect to the subjects in the every n evaluators is calculated to obtain a reference of a power approximation. And then, a power approximation expression is calculated based on the references of the power approximation with respect to the every n evaluators. The number of the evaluators who have evaluated the subject is applied to the power approximation expression so that the power approximation adjustment number of the evaluators is obtained. And the mean rating of the subject or the first adjustment mean rating of the subject are divided by the power approximation adjustment number of the evaluators to obtain a power approximation adjustment rating. Accordingly, the objective and highly accurate relative evaluation in the organization to which the subject belongs in relation to the subject corresponding to the number of the evaluators can be obtained.

Furthermore, it is preferable that Nmax is more than or equal to 5 (Nmax≥5), and n is less than or equal to Nmax−1 and more than or equal to 2 (Nmax−1≥n≥2). This allows to improve the accuracy of the standard deviation, since the total number of combinations of the ratings in every n evaluators is more than or equal to 2.

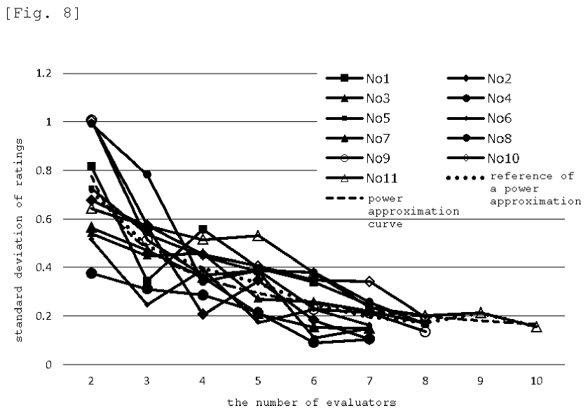

With reference to FIG. 8, one embodiment of power approximation expressions which are obtained by extracting a plurality of the subjects who have been evaluated by Nmax (Nmax≥5) evaluators and calculating the standard deviation for the total number of combinations of the ratings of every n (Nmax−1≥n≥2) evaluators is described. In FIG. 8, the subjects No. 1-11 who have been evaluated by more than or equal to 5 evaluators are extracted. The number of the evaluators (Nmax) who have evaluated the subjects No. 1-11 is 8 for No. 1-6, 9 for No. 7-10, and 11 for No. 11 respectively. The abscissa (x) of the graph in FIG. 8 represents the number of the evaluators (n) and the ordinate (y) of the graph in FIG. 8 represents the standard deviation.

Since the subject No. 7 has been evaluated by 8 evaluators, n is less than or equal to 7 and more than or equal to 2 (7≥n≥2). When n is equal to 2, the total number of combinations of 2 ratings selected from 8 ratings is 28. The standard deviations of each 28 combination are calculated respectively and the mean of the standard deviations is plotted upon the graph. When n is equal to 7, the total number of combinations of 7 ratings selected from 8 ratings is 8. The standard deviations of each 8 combination are calculated respectively and the mean of the standard deviations is plotted upon the graph. When Nmax is more than or equal to 5 (Nmax≥5), n is less than or equal to Nmax−1 and more than or equal to 2 (Nmax−1≥n≥2), the total number of combinations of the ratings in every n evaluators is more than or equal to 2. Therefore, the accuracy of the standard deviation can be enhanced.

Similarly, the means of the standard deviations in every n evaluators are calculated and plotted upon the graph with respect to the subjects No. 2-11. An average of the means of the standard deviations with respect to the subjects No. 1-11 in every n evaluators is calculated to be expressed as a reference of the power approximation. Accordingly, a power approximation expression based on the references of the power approximation can be obtained by using a least square method.

When the expression y=0.775x−0.7 is obtained as a power approximation expression and the number (x) of the evaluators who has evaluated an subject is 3, y≈0.36 is derived as a power approximation adjustment number of the evaluator. In addition, when the mean rating of the subject or the first adjustment mean rating of the subject is 4, 11.11 is derived as a power approximation adjustment rating by dividing the mean rating of the subject or the first adjustment mean rating of the subject by the power approximation adjustment number of the evaluator (4/0.36≈11.11).

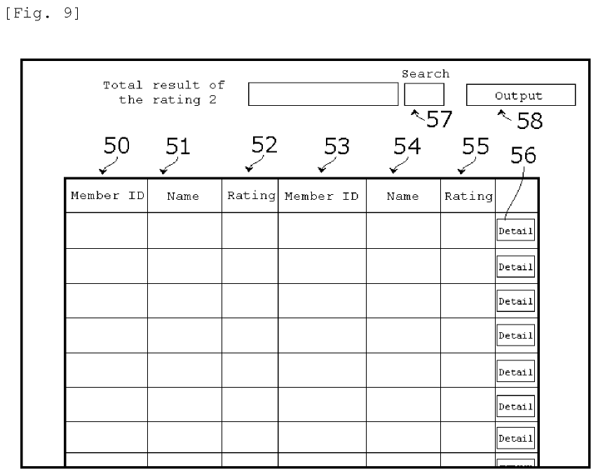

Furthermore, as shown FIG. 9, in the step of the evaluation data reading process S14, a pair of an evaluator and a subject who have given a good rating to one another and a pair of an evaluator and a subject who have given a poor rating to one another can be extracted respectively from the database server S2 to the web server S1 and can be displayed on the management terminal P1. Specifically, one member ID, name, and rating with respect to one of the pair who have given a good rating to one another are displayed in a member ID column 50, a name column 51 and an evaluation column 52 respectively. And another member ID, name, and rating are displayed in a member ID column 53, a name column 54 and an evaluation column 55 respectively. The same applies to the pair who have given a poor rating to one another. A search function 57 can be provided to display a desired data by typing a member ID or name.

As described above, when the pair of the evaluator and the subject who have given a good rating to one another are extracted and displayed, it is possible to estimate whether the evaluator and the subject mutually accept one another or whether there is no unfair evaluation. When the pair of the evaluator and the subject who have given a poor rating to one another are extracted and displayed, it is possible to know whether there are any troubles between them.

Additionally, a function to show the details of the displayed data can be provided. In FIG. 9, when a detail button 56 is submitted, the recorded ratings just in relation between the members who are displayed in the same line of the submitted detail button 56 are displayed.

When a totaled result output button 49 as shown in the display of FIG. 7 or a totaled result output button 58 as shown in the display of FIG. 9 is submitted in the step of the evaluation data output process S16 on the management terminal P1, various evaluation data displayed in the evaluation data reading process S14 can be output with a variety of data format such as CSV and then the data can be transmitted to the management terminal P1. Accordingly, it is convenient to manage or store the various data obtained by utilizing the human resource evaluation system 10 and apply to other system.

Since the evaluation data reading process S24 and the evaluation data output process S26 on the personnel terminal P2 are substantially similar to the evaluation data reading process S14 and the evaluation data output process S16 on the management terminal P1, explanations of the same process are omitted. A difference between them is the browsing and outputting range of the evaluation data. On the personnel terminal P2, a personnel who uses the personnel terminal P2 can read and output the evaluation data in relation to an organization ID of the organization to which the personnel belongs as a member, a group ID and a member ID to which the said organization ID is assigned. The other evaluation data in relation to an organization ID of the organization to which the personnel does not belong as a member, a group ID and a member ID to which the other organization ID is assigned cannot read or output on the personnel terminal P2.

It is preferable that the above human resource evaluation system 10 is performed by utilizing computers. Manual operation is, however, also possible, such as using a form printed the image as shown in FIG. 6 and totaling ratings recorded in the forms.

According to the human resource evaluation system described above, a personnel evaluation method and system which require a small number of steps for human resource evaluation and objectively evaluate personnel can be obtained.

### EXPLANATION OF REFERENCES

10 personnel evaluation system
30 evaluation item column

1. A personnel evaluation system in which a plurality of evaluators evaluates a subject or an evaluatee according to evaluation items comprising:
a display displaying the subject and the evaluation items with respect to each the plurality of evaluators;
an input means inputting a rating determined by selecting whether the subject is rated higher or lower than the evaluator oneself as a reference;
a memory storing the rating; and
a calculator calculating a mean rating of the subject dividing the sum of ratings which the subject has obtained by the total number of the evaluators and when the rating is not quantified, the calculator is converting a good rating which is obtained in the case of the subject is rated higher than the evaluator oneself as a reference to a larger fixed numerical score than that of a poor rating which is obtained in the case of the subject is rated lower than the evaluator oneself as a reference and the poor rating to a smaller fixed numerical score than that of the good rating.

2. The personnel evaluation system of claim 1, wherein the evaluator and the subject mutually evaluate one another according to the evaluation items.

3. The personnel evaluation system of claim 1, wherein there are many evaluators and subjects.

4. The personnel evaluation system of claim 2, wherein a first adjustment rating of the subject is calculated by adding a score obtained by subtracting an average score of the ratings which the evaluator has given to all subjects from the mean rating of the evaluator as a subject to a score which the evaluator has given to the subject; and
a first adjustment mean rating of the subject is calculated by dividing the sum of the first adjustment ratings of the subject by the total number of the evaluators who have evaluated the subject.

5. The personnel evaluation system of claim 1, wherein a log adjustment number of evaluators is calculated by adding a number which is greater than zero to the logarithm (the base is b>0, b≠1) of the number of the evaluators who have evaluated the subject (the evaluatee); and
a log adjustment rating is calculated by multiplying the mean rating of the subject or the first adjustment mean rating of the subject by the log adjustment number of the evaluators.

6. The personnel evaluation system of claim 1, wherein with respect to a subject who has been evaluated by Nmax (Nmax≥4) evaluators, at least one standard deviation for the total number of combinations of the ratings of every n (Nmax−1≥n≥2) evaluators is calculated and a mean of the standard deviation is calculated so that a reference of a power approximation is obtained;
a power approximation expression with respect to the every n evaluators is calculated based on the references of the power approximation;
the number of the evaluators who have evaluated the subject is applied to the power approximation expression so that the power approximation adjustment number of the evaluators is obtained; and
and the mean rating of the subject or the first adjustment mean rating of the subject is divided by the power approximation adjustment number of the evaluators to obtain a power approximation adjustment rating.

7. The personnel evaluation system of claim 3, wherein at least one standard deviation for the total number of combinations of the ratings of every n (Nmax≥n≥2) evaluators with respect to each a plurality of the subjects who have been evaluated by the Nmax (Nmax≥4) evaluators is calculated and a mean of the standard deviations is calculated;
an average of the means of the standard deviations with respect to the subjects in the every n evaluators is calculated to obtain a reference of a power approximation;
a power approximation expression with respect to the every n evaluators is calculated based on the references of the power approximation;
the number of the evaluators who have evaluated the subject is applied to the power approximation expression so that the power approximation adjustment number of the evaluators is obtained; and
the mean rating of the subject or the first adjustment mean rating of the subject is divided by the power approximation adjustment number of the evaluators to obtain a power approximation adjustment rating.

8. The personnel evaluation system of claim 6, wherein Nmax is more than or equal to 5 (Nmax≥5), and n is less than or equal to Nmax−1 and more than or equal to 2 (Nmax−1≥n≥2).

9. The personnel evaluation system of claim 1, the system further comprising an extracting means extracting a pair of subjects who have mutually evaluated one another according to evaluation items and have given the good rating to one another or extracting a pair of the subjects who have mutually evaluated one another according to evaluation items and have given the poor rating to one another.

10. The personnel evaluation system of claim 2, wherein there are many evaluators and subjects.

11. The personnel evaluation system of claim 3, wherein a first adjustment rating of the subject is calculated by adding a score obtained by subtracting an average score of the ratings which the evaluator has given to all subjects from the mean rating of the evaluator as a subject to a score which the evaluator has given to the subject; and
a first adjustment mean rating of the subject is calculated by dividing the sum of the first adjustment ratings of the subject by the total number of the evaluators who have evaluated the subject.

12. The personnel evaluation system of claim 10, wherein a first adjustment rating of the subject is calculated by adding a score obtained by subtracting an average score of the ratings which the evaluator has given to all subjects from the mean rating of the evaluator as a subject to a score which the evaluator has given to the subject; and
a first adjustment mean rating of the subject is calculated by dividing the sum of the first adjustment ratings of the subject by the total number of the evaluators who have evaluated the subject.

13. The personnel evaluation system of claim 2, wherein a log adjustment number of evaluators is calculated by adding a number which is greater than zero to the logarithm (the base is b>0, b≠1) of the number of the evaluators who have evaluated the subject (the evaluatee); and
a log adjustment rating is calculated by multiplying the mean rating of the subject or the first adjustment mean rating of the subject by the log adjustment number of the evaluators.

14. The personnel evaluation system of claim 3, wherein a log adjustment number of evaluators is calculated by adding a number which is greater than zero to the logarithm (the base is b>0, b≠1) of the number of the evaluators who have evaluated the subject (the evaluatee); and
a log adjustment rating is calculated by multiplying the mean rating of the subject or the first adjustment mean rating of the subject by the log adjustment number of the evaluators.

15. The personnel evaluation system of claim 4, wherein a log adjustment number of evaluators is calculated by adding a number which is greater than zero to the logarithm (the base is b>0, b≠1) of the number of the evaluators who have evaluated the subject (the evaluatee); and
a log adjustment rating is calculated by multiplying the mean rating of the subject or the first adjustment mean rating of the subject by the log adjustment number of the evaluators.

16. The personnel evaluation system of claim 2, wherein with respect to a subject who has been evaluated by Nmax (Nmax≥4) evaluators, at least one standard deviation for the total number of combinations of the ratings of every n (Nmax−1≥n≥2) evaluators is calculated and a mean of the standard deviation is calculated so that a reference of a power approximation is obtained;
a power approximation expression with respect to the every n evaluators is calculated based on the references of the power approximation;
the number of the evaluators who have evaluated the subject is applied to the power approximation expression so that the power approximation adjustment number of the evaluators is obtained; and
and the mean rating of the subject or the first adjustment mean rating of the subject is divided by the power approximation adjustment number of the evaluators to obtain a power approximation adjustment rating.

17. The personnel evaluation system of claim 3, wherein with respect to a subject who has been evaluated by Nmax (Nmax≥4) evaluators, at least one standard deviation for the total number of combinations of the ratings of every n (Nmax−1≥n≥2) evaluators is calculated and a mean of the standard deviation is calculated so that a reference of a power approximation is obtained;
a power approximation expression with respect to the every n evaluators is calculated based on the references of the power approximation;
the number of the evaluators who have evaluated the subject is applied to the power approximation expression so that the power approximation adjustment number of the evaluators is obtained; and
and the mean rating of the subject or the first adjustment mean rating of the subject is divided by the power approximation adjustment number of the evaluators to obtain a power approximation adjustment rating.

18. The personnel evaluation system of claim 4, wherein with respect to a subject who has been evaluated by Nmax (Nmax≥4) evaluators, at least one standard deviation for the total number of combinations of the ratings of every n (Nmax−1≥n≥2) evaluators is calculated and a mean of the standard deviation is calculated so that a reference of a power approximation is obtained;
a power approximation expression with respect to the every n evaluators is calculated based on the references of the power approximation;
the number of the evaluators who have evaluated the subject is applied to the power approximation expression so that the power approximation adjustment number of the evaluators is obtained; and
and the mean rating of the subject or the first adjustment mean rating of the subject is divided by the power approximation adjustment number of the evaluators to obtain a power approximation adjustment rating.

19. The personnel evaluation system of claim 4, wherein at least one standard deviation for the total number of combinations of the ratings of every n (Nmax≥n≥2) evaluators with respect to each a plurality of the subjects who have been evaluated by the Nmax (Nmax≥4) evaluators is calculated and a mean of the standard deviations is calculated;
an average of the means of the standard deviations with respect to the subjects in the every n evaluators is calculated to obtain a reference of a power approximation;
a power approximation expression with respect to the every n evaluators is calculated based on the references of the power approximation;
the number of the evaluators who have evaluated the subject is applied to the power approximation expression so that the power approximation adjustment number of the evaluators is obtained; and
the mean rating of the subject or the first adjustment mean rating of the subject is divided by the power approximation adjustment number of the evaluators to obtain a power approximation adjustment rating.

20. The personnel evaluation system of claim 7, wherein Nmax is more than or equal to 5 (Nmax≥5), and n is less than or equal to Nmax−1 and more than or equal to 2 (Nmax−1≥n≥2).
